(19) United States
(12) Patent Application Publication
(10) Pub. No.: US 2008/0244505 A1
(43) Pub. Date: Oct. 2, 2008

(54) System and Method for Programming

(76) Inventors: Shrage Smilowitz, Monroe, NY (US); Malcolm S. Meyers, London (GB)

Correspondence Address: DIEHL SERVILLA LLC, 77 BRANT AVE, SUITE 210, CLARK, NJ, 07066, US

(21) Appl. No.: 11/691,855

(22) Filed: Mar. 27, 2007

(51) Int. Cl. G06F 9/44

(52) U.S. Cl. 717/100

(57) ABSTRACT

The present invention provides an open system and method for collaborative development of object oriented computer applications. The system includes a Logic Builder website connected to the internet that stores programming logic and a plurality of classes. The Logic Builder website can be used to search object websites connected to the internet for objects in each of the plurality of classes and can be used to develop programs from selected objects.

### FIELD OF THE INVENTION

The present invention relates to software programming. More specifically, it relates to system and method for providing an open logic system that can be build and used by the web community and can be updated in real time.

### BACKGROUND OF THE INVENTION

Programming is a difficult task. There are many common tasks that are performed by many programs. These tasks have to be repeated many times by many different programmers, creating much duplication of effort. Further the tools used tend to be very complicated and difficult to use.

Accordingly, new simple programming tools are needed.

The present invention provides a system and method to avoid replication of efforts by allowing objects to be easily reused. The present invention therefore solves significant problems in the programming community.

### SUMMARY OF THE INVENTION

One aspect of the present invention provides an open system for collaborative development of object oriented computer applications. The system includes a Logic Builder website connected to the internet that stores programming logic and a plurality of classes, wherein the Logic Builder website can be used to search object websites connected to the internet for objects in each of the plurality of classes and can be used to develop programs from selected objects.

In accordance with a further aspect of the present invention, the programs can be executed at application websites connected to the internet. By way of example only, the programs can be executed at application websites connected to the internet by receiving programming logic from the Logic Builder website and objects from one or more of the plurality of classes. Alternatively, the programs can be executed at application websites connected to the internet by passing the Logic Builder the location of an object, or passing a copy of the object, and asking the Logic Builder website to run the logic against that object, the logic may return logic results.

In accordance with further aspects of the present invention, the object websites can be searched via a registry of objects. The registry can maintain a history and version control of a plurality of objects. Alternatively, the object websites can be searched via a search engine.

In accordance with a further aspect of the present invention, the Logic Builder website can be used to create objects.

The system of the present invention can also control access to the Logic Builder website so that it is limited to validated members. This can be controlled by use of user names and passwords.

Programs using this logic system can be executed as a Web based application in accordance with another aspect of the present invention. In accordance with alternate aspects of the invention, programs using this logic system can be executed as a desktop based application.

The present invention also allows a program to be formed by the system by combining a plurality of objects from different websites.

A discussion forum can also be provided. The forums can be provided for each class in the system or by any other division desired.

The present invention also contemplates a method for collaborative development of object oriented computer applications. The method includes accessing a Logic Builder website connected to the internet that stores programming logic and a plurality of classes, searching for objects in one or more of the plurality of classes located at object websites connected to the internet and developing programs using selected objects and programming logic.

All of the previously discussed features of the system of the present invention can be provided in the method of the present invention.

### DESCRIPTION OF THE DRAWINGS

FIG. 1 illustrates the elements of the open logic system in accordance with one aspect of the present invention.

FIG. 2 illustrates a first version of a contact list in accordance with one aspect of the present invention.

FIG. 3 illustrates a second version of a contact list in accordance with one aspect of the present invention.

FIG. 4 illustrates an object used in accordance with another aspect of the present invention.

FIG. 5 illustrates another aspect of the present invention.

### DESCRIPTION OF A PREFERRED EMBODIMENT

The present invention has several goals. One goal is to provide a collaborative programming environment, whereby developers from around the world can describe entities, logic and intelligence, together in a complete collaborative way.

Another goal of the open logic system of the present invention is to provide a real-time programming environment whereby logic and code are available to use in real-time. It is also a further goal to provide logic and application level sharing capabilities wherein the logic system can be used by anyone. It is another object to provide duplicate free logic for use programmers. Thus, the system of the present invention produces the minimum duplicate logic across its whole logic base.

The system of the present invention provides distributed objects and each object can reside at a different location. The system of the present invention provides a central version history and control for each individual class of objects. It also supports Web applications and desktop applications, and introduces a new powerful search and compare mechanism.

The system of the present invention includes WikiClasses. These are descriptions of entities that are described by programmers using properties and logic. For example, one WikiClass is a “car.” With properties such as Name, Model, Manufacturer, and logic such as StartEngine, Horn. The system also includes WikiObjects, which are instances of a class. For example, a WikiObject may be a “Lexus,” which is an instance of a car with its property name set to “Lexus”. The system further provides WikiData. This is data about objects, for example what is the amount of “metal” used in a “Lexus LS07”, what are the dimensions, how many lights does it have, etc. WikiClasses, WikiObjects and WikiData can be provided by any user signed up to the system. An Online Developer Tool is also provided where developers write the code to describe world objects, and where users can add data about objects.

An example of the system usage follows. A developer writes up a class called a WikiObject. The class represents an entity in the world, for example a car. This version of the car is a basic one, it has properties such as Name, Color, Model, Make and Wheels. The developer also adds some functionalities like StartEngine, CloseEngine, PushPaddle, Break. These functions implement some logic to imitate the events of a car as in the actual world. For example, when you start an engine, then press the paddle, the wheels start to turn. Likewise when a developer uses a Car object and calls the StartEngine function and then the PushPaddle function, the wheels will start to turn in the virtual world.

If another developer then would like to describe a truck, he doesn't have to recreate all functionality of a truck which uses much the same basic functionality as a car, he can inherit its core functionality from the BasicCar object, all its functionality will be as part of the truck object, but the developer can then add additional properties and functions which are related to a truck. For example, he can add a property called “Box” that represents the back box on a truck.

Any other developer can later also update this truck object and improve its logic all in real time, before making an update the developer can post suggestions, communicate with other developer till the right new punctuality is decided, just as writers of information do on wikipedia.org.

Each object can contain properties that represent other kind of objects. For example a car can have two “light” objects, but what a “light” is can be described by a different developer.

What happens is that the system can become a web of objects and logic that will result in each object getting indirect properties and features from the hierarchy of objects it relates to. For example, if one developer adds a “material” property to all car objects, and another developer has developed logic to describe what “material” is, one of the properties of “material” would be “weight” so different types of “material” weighs different then the other. Now since a car uses the property “material” you can indirectly find out the “weight” of a car by using the logic and data someone else has provided on “material” and calculating the “amount” of material in a “car.” The purpose of WikiData is to provided a central place where Wiki Applications can get read “more information” about an entity such as a car, information that is not provided by WikiObjects.

There are two ways how the system can allow open editing but still be reliable to use. One way is by applying the rule that no class can be deleted, and all objects are available for the public to use. Whenever a developer changes a class a new version number is assigned, the system keeps all versions of a class and you refer to a class by using its class name and version number.

The second way is by the system providing a set of predefined objects which cannot be changed by any one, developers can add their own properties and logic, you can keep version number for each change that a developer makes, or you can enforce just one version of a class for each developer, the system tracks all custom properties and its usage amount, the system displays these information for the public, at any given time decided by the system owner a new public version of the class is defined based on the most common used properties and logic, the cycle goes on for the next versions.

The present invention provides revolutionary search and comparison capabilities. It allows a programmer to make such kind of searches like “Search for all coats that aren't worn in rain” or comparisons like “Give me the difference between a dress made from silk vs. cotton” or “What will be the difference in gas expense using a Toyota Camry and a Honda Acura.” Providing these search capabilities for objects are similar to those searches performed by internet search engines and are well known in the art.

The present open Logic System is a blend of the following technologies and ideas: Web Services, Online Programming and Application Host Services (OPAS) such as offered by CogHead.com and SalesForce.com, and Open Source/Community Programming.

OPAS, for example, is a Real Time Programming or application system that allows to share full written applications It does not allow Logic and class level sharing. Thus, with OPAS you can share a full application with your friends so they can “Access” and “utilize” this application. They can “Copy” this application for their own editing, or they can “Edit” the full application as a whole”. You cannot refer to an individual class and you cannot edit code only by copying the full application and editing it. OPAS also results in duplicate applications, logic and classes. This happens because you cannot share logic with other developers you end up with the logic reproduced on several applications and no one is interested in improving someone else's code because they can hide it within their own application. CogHead does not provide a central place of all versions of a particular class, each class is delivered intertwined with other classes as a full framework, so each version of a single class resides in a different deployment of a full new framework version. CogHead also does not allow you to host each piece of an application at a different location, and CogHead does not have such things WikiObject which are distributed instances of a class which represents classes in the system. It also doesn't have such things as WikiData which is a shared object data base.

WebServices allows you to share your logic with the public. Web Services, however, doesn't allow you to describe objects. Instead, one just describes functions and each functions is separate from the other, with no connections. Thus, for example, there is no way you can describe a car using WebServices.

The Open Source/Community Programming provides a philosophy to build software using the brain power of the world by opening up the source code of an application. It does not, however, allow real time programming. The need to download software, compile it, install it, is very involved and complicated. The Open Source/Community Programming approach also results in duplicate logic and classes all over the internet. Additionally, there is no central place of all versions of a particular class, each class is delivered intertwined with other classes as a full framework, so each version of a single class resides in a different deployment of a full new framework version.

Various aspects of the present invention will now be discussed with reference to the attached drawings.

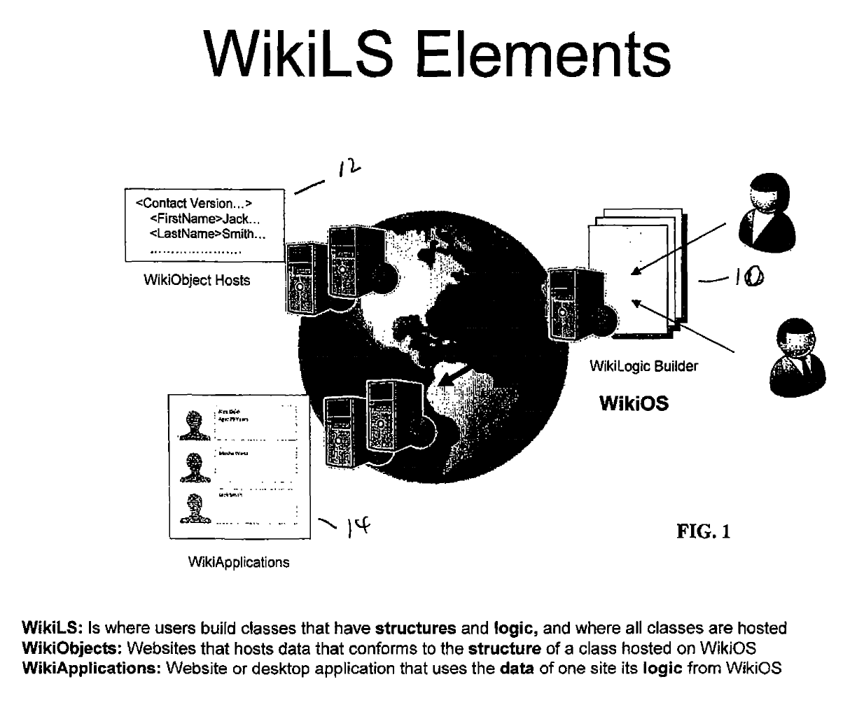

Referring to FIG. 1, the elements of the open logic system in accordance with one aspect of the present invention are illustrated. The open logic system is where users build classes that have properties and logic. All classes are hosted by the open logic system.

In accordance with one aspect of the present invention, the open logic system includes a Logic Builder website 10, a plurality of websites 12 that host objects and a plurality of websites 14 that can execute programs developed by the system. The Logic Builder website 10 is used by a programmer to generate a program. More specifically, users of the Logic Builder website 10 build classes that have structures and logic.

In accordance with one aspect of the present invention, only authorized users are permitted to use the Logic Builder website 10. Those users can access programming logic tools and classes of objects. The programming logic tools and the classes are stored by the Logic Builder website for use by programmers. They can be stored at the Logic Builder website 10 or at an alternative storage location.

The websites 12 host objects that are used at the Logic Builder 10 to generate object oriented programs. The objects have an identifier that specifies which class of objects maintained by the Logic Builder website 10 that they belong to. The website 12 hosts data that conforms to the structure of a class hosted by the Logic Builder website 10 to define the objects. The websites 14 use the objects from one or more of the websites 12 and logic from the Logic Builder 10 to run applications or programs.

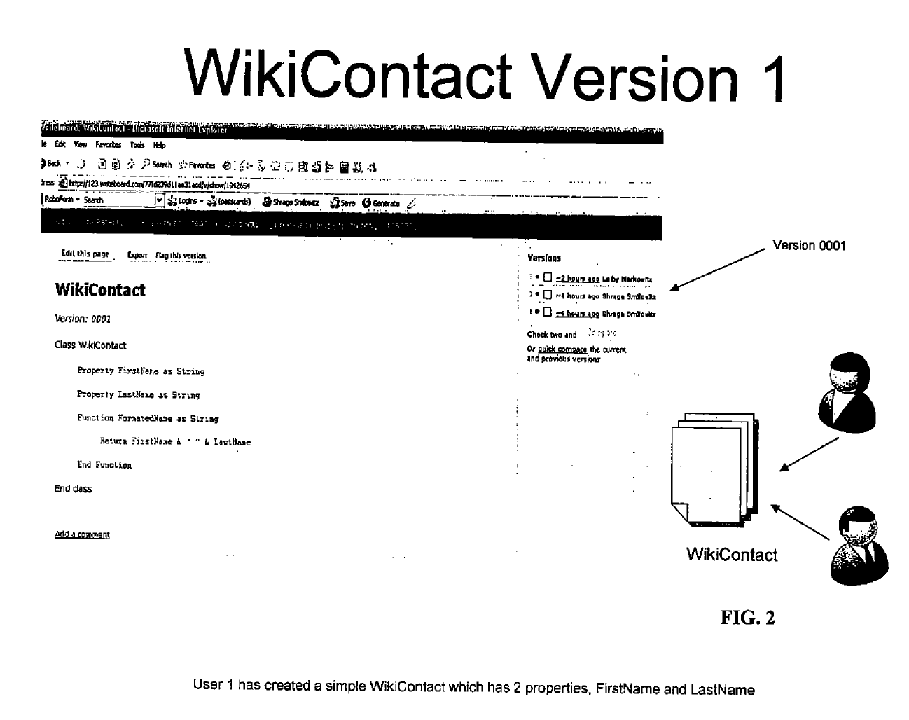

FIG. 2 illustrates an object hosted at a website 12. This object is called WikiContact Version 1. It has two properties, FirstName and LastName. It is a very simple object. If a programmer is generating a contact list program, then the programmer could search available objects using an object search engine or a registry of objects provided by the Logic Builder website 10 to find objects that conform to a selected class, including the WikiContact Version 1 object. If this object did not completely meet the needs of the programmer, then it could be modified or another object can be selected.

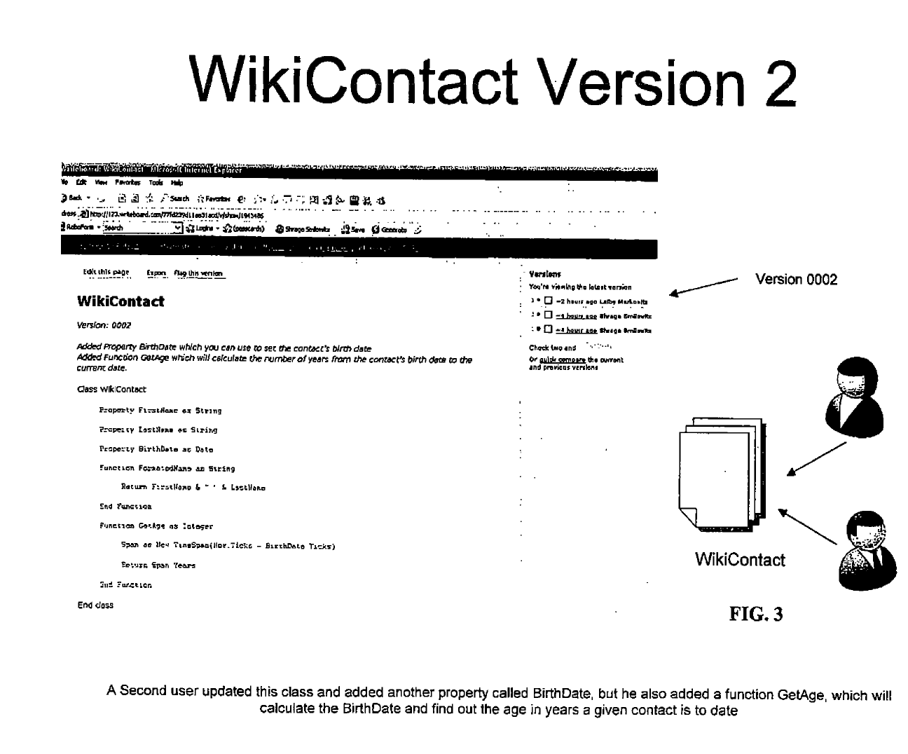

FIG. 3 illustrates a second version of the object called WikiContact Version 2. As the note at the top of the object indicates, the programmer added the property BirthDate and a function GetAge. The property BirthDate is the date of birth of the person on the contact list. The function GetAge calculates the age of the person based on the date of birth. This object is also stored at the Object Host website and is also available to other programmers. In accordance with one aspect of the present invention, it is only available to those programmers that are registered users of the system.

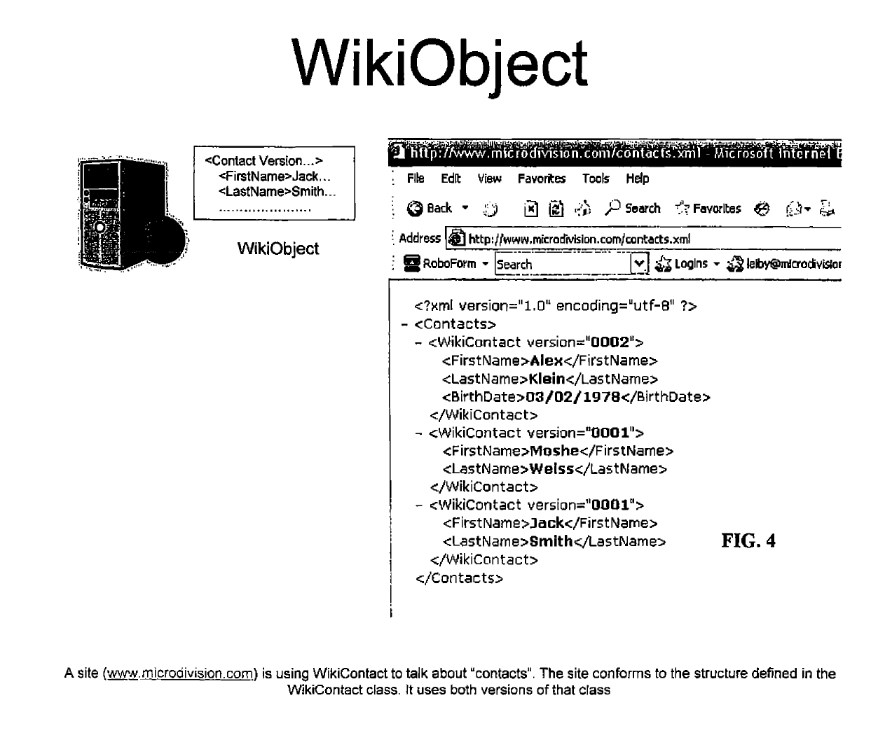

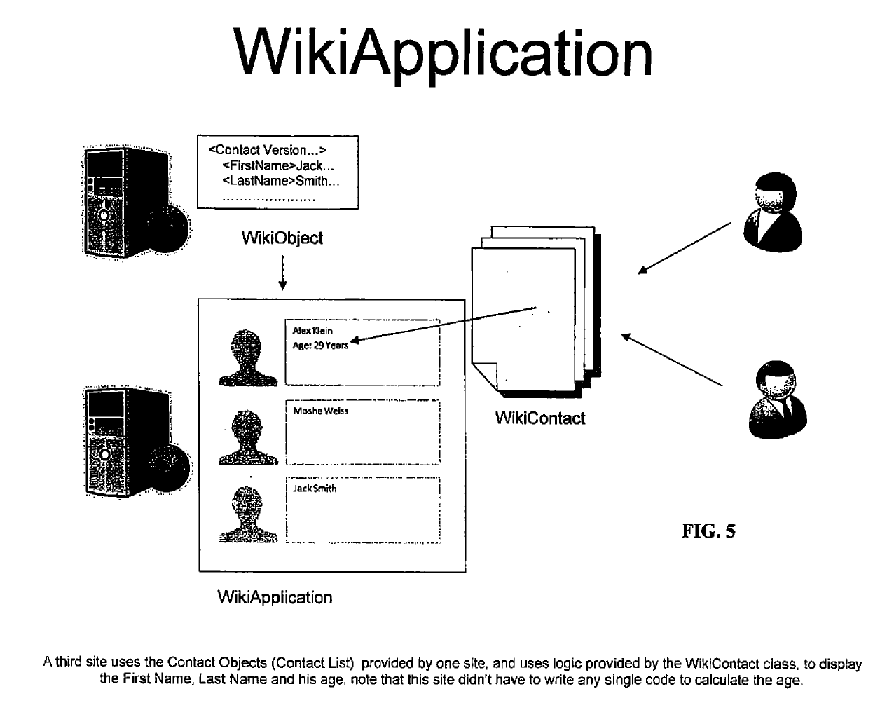

FIG. 4 illustrates a web site using the WikiContact object to talk about contacts. The site conforms to the structure defined in the logic and class defined by the Logic Builder website 10 and to the data in the object from the website 12. FIG. 5 illustrates another aspect of the present invention wherein programs or applications are executed. A website, such as the application web site 14 of FIG. 1, uses the objects provided by one or more sites and uses logic provided by a class at a Logic Builder 10 to display the first and last name of contacts and the ages of the contacts. This site did not have to write any code to calculate the age—instead it uses the logic received from the Logic Builder website 10.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. An open system for collaborative development of object oriented computer applications, comprising:
a Logic Builder website connected to the internet that stores programming logic and a plurality of classes;
wherein the Logic Builder website can be used to search object websites connected to the internet for objects in each of the plurality of classes and can be used to develop programs from selected objects.

2. The system of claim 1, wherein the programs can be executed at application websites connected to the internet.

3. The system of claim 1, wherein the programs can be executed at application websites connected to the internet by receiving programming logic from the Logic Builder website and objects from one or more of the plurality of classes.

4. The system of claim 1, wherein the programs can be executed at application websites connected to the internet by passing the Logic Builder the location of an object, or passing a copy of the object, and asking the Logic Builder website to run the logic against that object, the logic may return logic results.

5. The system of claim 1, wherein the object websites can be searched via a registry of objects.

6. The system of claim 5, wherein the registry maintains a history and version control of a plurality of objects.

7. The system of claim 1, wherein the object websites can be searched via a search engine.

8. The system of claim 1, wherein the Logic Builder website can create objects.

9. The system of claim 1, wherein access to the Logic Builder website is limited to validated members.

10. The system of claim 1, wherein programs using this logic system can be executed as a Web based application.

11. The system of claim 1, wherein programs using this logic system can be executed as a desktop based application.

12. The system of claim 1, wherein a program can be formed by the system by combining a plurality of objects from different websites.

13. The system of claim 1, further comprising a discussion forum for each class in the system.

14. A method for collaborative development of object oriented computer applications, comprising:
accessing a Logic Builder website connected to the internet that stores programming logic and a plurality of classes;
searching for objects in one or more of the plurality of classes located at object websites connected to the internet;
developing programs using selected objects and programming logic.

15. The method of claim 14, further comprising executing the program at application websites connected to the internet.

16. The method of claim 14, wherein the programs can be executed at application websites connected to the internet by receiving programming logic from the Logic Builder website and objects from one or more of the plurality of classes.

17. The method of claim 14, wherein the object websites are searched via a registry of objects.

18. The method of claim 17, wherein the registry maintains a history and version control of a plurality of objects.

19. The method of claim 14, wherein the object websites are searched via a search engine.

20. The method of claim 14, further comprising limiting access to the Logic Builder website to validated members.

21. The method of claim 14, wherein a program can be executed as a Web based application.

22. The method of claim 14, wherein a program can be executed as a desk top based application.

23. The method of claim 14, wherein a program is formed by combining a plurality of objects from different websites.

24. The method of claim 14, further comprising providing a discussion forum.
